(19) United States
(12) Patent Application Publication
(10) Pub. No.: US 2018/0261971 A1
(43) Pub. Date: Sep. 13, 2018

(54) BIDIRECTIONAL C-BAND AND L-BAND OPTICAL TRANSMISSION USING CIRCULATORS

(71) Applicant: NEC Laboratories America, Inc., Princeton, NJ (US)

(72) Inventors: Fatih YAMAN, PRINCETON, NJ (US); Shaoliang ZHANG, PRINCETON, NJ (US); Eduardo Mateo RODRIGUEZ, TOKYO (JP); Kohei NAKAMURA, TOKYO (JP); Takanori INOUE, TOKYO (JP); Yoshihisa INADA, TOKYO (JP)

(21) Appl. No.: 15/911,475

(22) Filed: Mar. 5, 2018

Related U.S. Application Data
(60) Provisional application No. 62/467,282, filed on Mar. 6, 2017.

(51) Int. Cl. H01S 3/094; H01S 3/067

(52) U.S. Cl. CPC H01S 3/094023; H01S 3/094011; H01S 3/06787; H01S 3/0677; H01S 3/06766

(57) ABSTRACT

Aspects of the present disclosure describe systems, methods, and structures for providing bidirectional C-band and L-band transmission employing optical circulators which advantageously eliminates C\L WDM couplers while still blocking any backward amplified spontaneous emissions from optical amplifiers.

### CROSS REFERENCE TO RELATED APPLICATIONS

This application claims the benefit of U.S. Provisional Patent Application Ser. No. 62/467,282 filed Mar. 6, 2017 which is incorporated by reference as if set forth at length herein.

### TECHNICAL FIELD

This disclosure relates generally to optical communications and more specifically to novel systems, methods, and structures providing bidirectional C and L band optical transmission using optical circulators.

### BACKGROUND

As is known, deploying new optical fiber for optical communications facilities and networks constructed therefrom is quite expensive. Consequently, the art has expended considerable intellectual and financial capital developing and/or deploying technologies that facilitate and/or enhance transmission capacity of existing facilities. Notwithstanding this considerable expenditure, there remains a continuing need for systems, methods, and structures that enhance the transmission capacity and information carrying ability of optical communications networks and such systems, methods, and structures would represent a welcome addition to the art.

### SUMMARY

An advance in the art is made according to aspects of the present disclosure directed to systems, methods, and structures that advantageously provide bidirectional C-band and L-band transmission employing optical circulators.

In sharp contrast to the prior art—systems methods, and structures according to the present disclosure eliminate—and do not employ—any C\L WDM couplers while advantageously still blocking any backward amplified spontaneous emissions from optical amplifiers.

In an illustrative embodiment, an apparatus according to the present disclosure comprises: a first optical waveguide having a first end and a second end; a second optical waveguide having a first end and a second end; a third optical waveguide having a first end and a second end; a fourth optical waveguide having a first end and a second end; a first optical circulator, said first circulator in optical communication with the second end of the first optical waveguide, the first end of the third optical waveguide and the first end of the fourth optical waveguide; a second optical circulator, said second optical circulator in optical communication with the second end of the third optical waveguide, the second end of the fourth optical waveguide, and the first end of the second optical waveguide, a first optical amplifier interposed between the first end and the second end of the third optical waveguide; a second optical amplifier interposed between the first end and the second end of the fourth optical waveguide; wherein the apparatus is configured such that there are no optical isolators interposed between the circulators and the optical amplifiers.

Of further advantage, systems, methods, and structures according to the present disclosure advantageously provide bidirectional C-band and L-band optical transmission where the C-band and the L-band travel in opposite directions.

### BRIEF DESCRIPTION OF THE DRAWING

A more complete understanding of the present disclosure may be realized by reference to the accompanying drawing in which:

FIG. 1 is a plot of attenuation vs. wavelength illustrating fiber attenuation and transmission bands employed in contemporary optical fiber transmission facilities and networks;

FIG. 2 is a schematic diagram showing an illustrative unidirectional implementation of C and L band transmission;

FIG. 3 is a schematic diagram showing an illustrative bidirectional implementation of C and L band transmission;

FIG. 4 is a schematic diagram showing an illustrative, contemporary duplex unidirectional implementation of C and L band transmission;

FIG. 5 is a schematic diagram showing an illustrative duplex bidirectional implementation of C and L band transmission;

FIG. 6 is a schematic diagram showing an illustrative bidirectional C\L amplifier using circulators instead of C\L wavelength-division-multiplexed (WDM) couplers according to aspects of the present disclosure; and

FIG. 7 is a schematic diagram showing an illustrative implementation of bidirectional C and L band transmission and components of Erbium-doped fiber amplifiers.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Drawing, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the FIGs comprising the drawing are not drawn to scale.

By way of some additional background, we note that optical fibers are generally very thin (˜250-micron diameter) strands of glass that can advantageously be employed to guide light with low attenuation. Despite this low attenuation, they nevertheless can experience a drop in optical power of 1% over a single span. Accordingly—and to overcome such attenuation drop in optical fiber—the art has employed optical amplifiers as part of repeater assemblies to amplify the optical power lost to the attenuation. In illustrative repeater assemblies, there is one amplifier dedicated to each individual optical fiber.

As is known by those skilled in the art, wavelength division multiplexing (WDM) is one of many major developments made to increase the data carrying capacity of optical networks. With WDM configurations, additional data carrying capacity(ies) are added to existing optical networks by increasing the number of data carrying wavelengths in the optical fibers. Accordingly, data carrying capacity of an individual fiber may be increased by employing more individual wavelengths in that fiber.

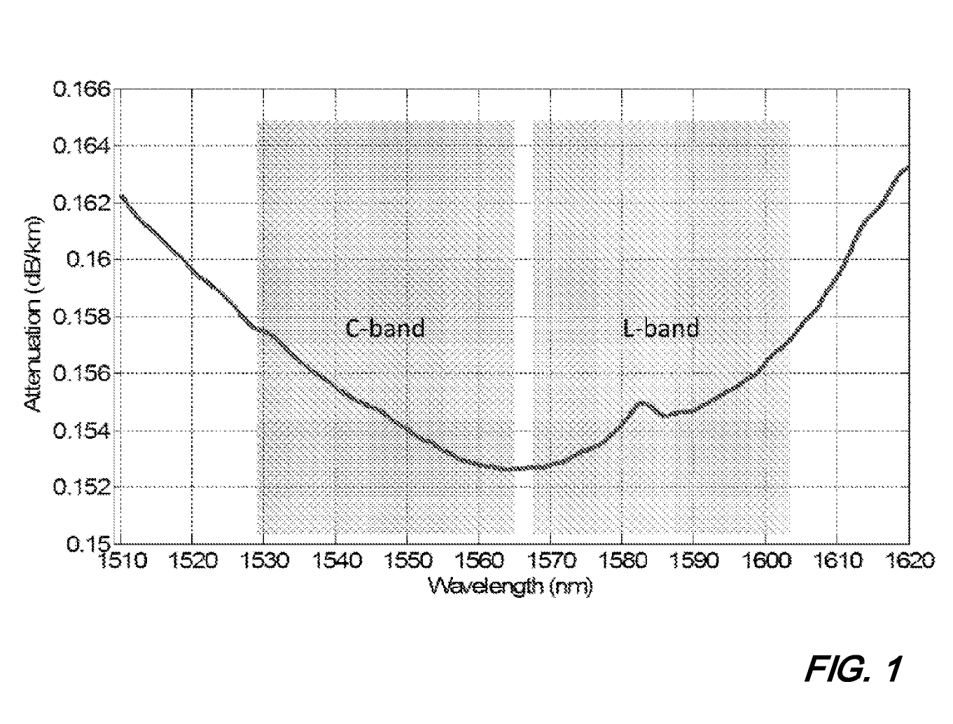

While such capacity of a fiber can be increased by utilizing more and more wavelengths however, there is a limit to how many wavelengths a fiber can support. One such limitation results from the wavelength dependence of the attenuation of the fiber as shown in FIG. 1. As may be observed from that figure, attenuation is low only for a limited bandwidth—roughly between 1510 nm to 1620 nm—beyond which the attenuation becomes too large.

Another such limitation results from the amplification bandwidth of the amplifiers employed. More particularly, in fiber communication systems employing repeaters, the amplifiers used are almost exclusively of a type known in the art as erbium-doped fiber amplifiers (EDFAs) which may advantageously amplify roughly 30-40 nm of the overall bandwidth.

As is further known, there are two bands that are most relevant to long distance communications are shown in FIG. 1 as the C-band and the L-band. In contemporary optical systems, the C-band is primarily used as shown illustratively in the figure. Note that the location of this C-band is determined by physical parameters of the amplifiers used.

Those skilled in the art will readily understand and appreciate that it is possible to cover the L-band using similar amplifiers with a distinct design namely, L-band amplifiers Typically, L-band EDFAs exhibit a slightly worse performance as compared to C-band EDFAs—even though they cover roughly the same amount of bandwidth. As a result, C-band EDFAs are oftentimes used first. However, and as will become apparent and according to the present disclosure—the advantage(s) of using C- and L-band together is clear. For example, once the capacity of a C-band EDFA is exhausted, it is nevertheless possible to nearly double the capacity of a fiber by adding L-band amplifiers to repeater locations including C-band amplifiers. As will be readily understood by those skilled in the art, such “upgrade” may provide significant cost savings as compared with deploying additional optical fiber.

To fully appreciate how systems, methods, and structures according to the present disclosure operates, we provide some additional background about implementing combined C-band and L-band transmission.

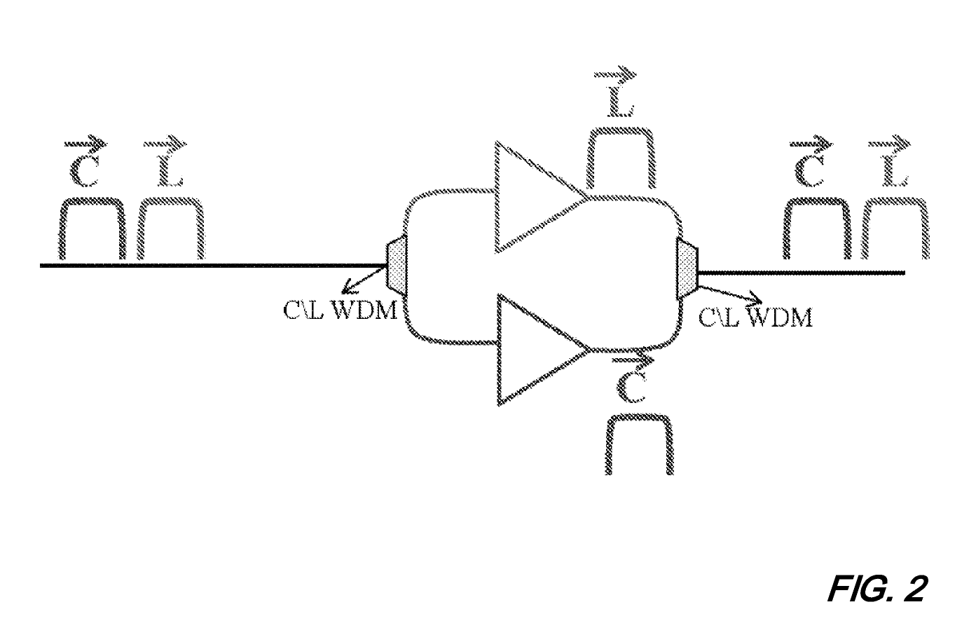

As is known, C-band(s) and L-band(s) are separate, and EDFAs employed are specific for amplification of their associated C-band signals and L-band signals only. As a result, prior to amplification, the C-band(s) and L-band(s) must be separated and the separate signals applied to appropriate amplifier(s). Conversely, after amplification, they need to be re-combined such that they traverse a common fiber once again. This illustrated schematically in FIG. 2.

As may be observed from that figure, C-band and L-band signals are shown propagating along a common optical path. The signals are separated through the effect of—for example—a C\L WDM coupler (also known as a WDM coupler or band coupler) and then directed into separate optical paths. These separate optical paths include amplifiers configured to amplify the particular signals traversing therein and the amplified signals are subsequently re-combined (by another C\L WDM for example) and the re-combined signals are output via a common optical path (fiber).

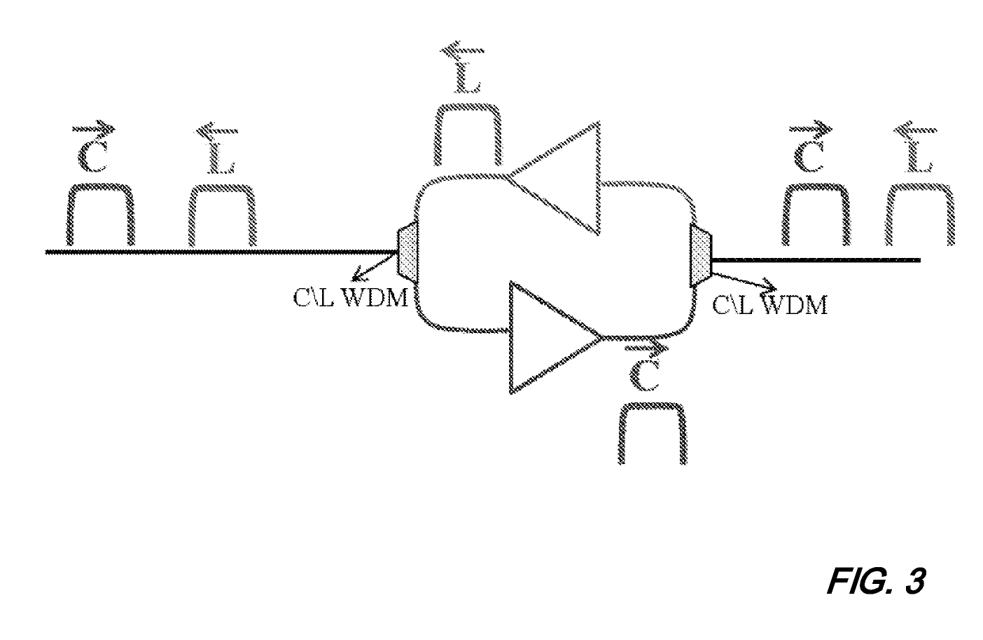

We note that a configuration such as that shown in FIG. 2 is known in the art as a unidirectional transmission system in that the C- and L-band signals travel in the same direction. If, however, the C-band and L-band signals travel in opposite directions, such configurations are known in the art as bidirectional transmission systems and such a bidirectional system is shown schematically in FIG. 3. Note that since C\L WDM couplers as employed both split and combine optical signals based on their wavelengths, such couplers may advantageously be employed in both unidirectional and bidirectional systems.

Additionally, we note that what is shown in FIG. 2 and FIG. 3 is in fact only half of the system. Most systems are duplex transmission systems. As will be appreciated, with a duplex transmission system, for every data traveling from point A to point B there is a matching data channel carrying data from point B back to point A. In almost all cases a duplex transmission is achieved by a fiber pair. Basically, one of the fibers carry data from point A to B and the other fiber carries data from point B to point A.

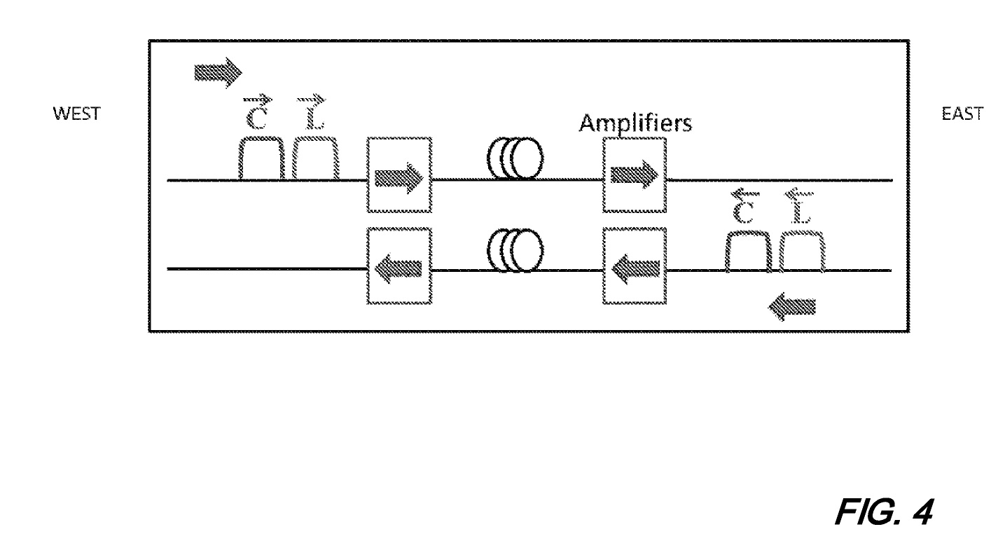

Turning now to FIG. 4, there is shown a schematic of an illustrative duplex transmission system in which on fiber (or several fiber spans) carries traffic in one direction (i.e., West to East) while another fiber (or several spans) carries traffic in an opposite direction. Note that both C-band and L-band signals may be carried on the directional fibers.

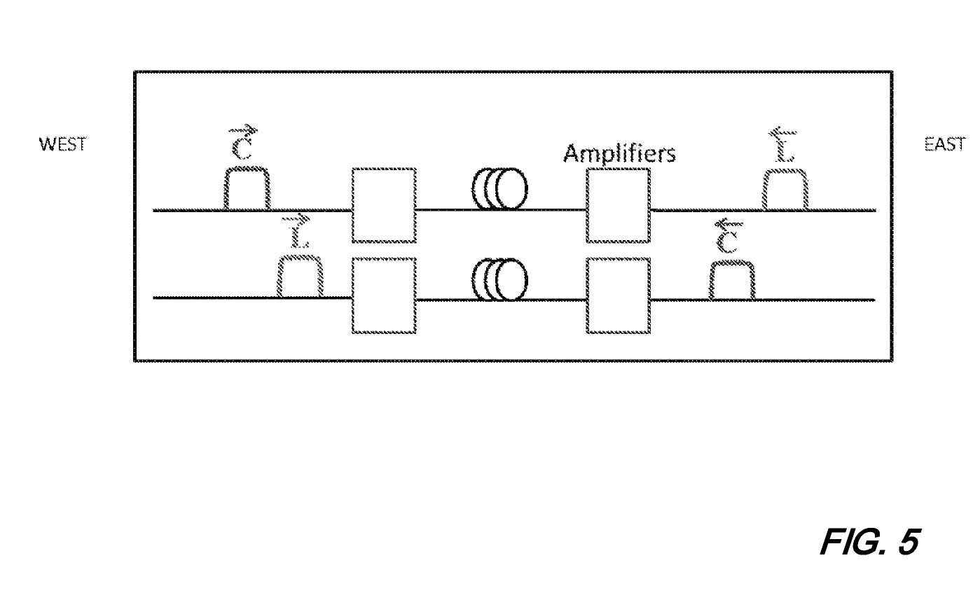

FIG. 5 shows in schematic form an illustrative configuration for a bidirectional, duplex link. As may be observed from that figure, the top fiber carries—for example—C-band signals from West to East, while the bottom fiber carries C-band from East to West. Shown further in that figure the top fiber carries L-band signals from East to West, while the bottom fiber carries L-band signals from West to East.

Note that duplex bidirectional links are—as far as we know—not implemented in any known installation.

Returning now to our discussion of FIG. 3, we note that according to the present disclosure one may advantageously employ circulators instead of C\L couplers to implement the splitting and recombining of the C-band and L-band signals. Whereas the C\L band WDM couplers of FIG. 3 differentiate and direct signals based on their wavelengths, circulators differentiate, and direct signals based on the direction in which they are traveling.

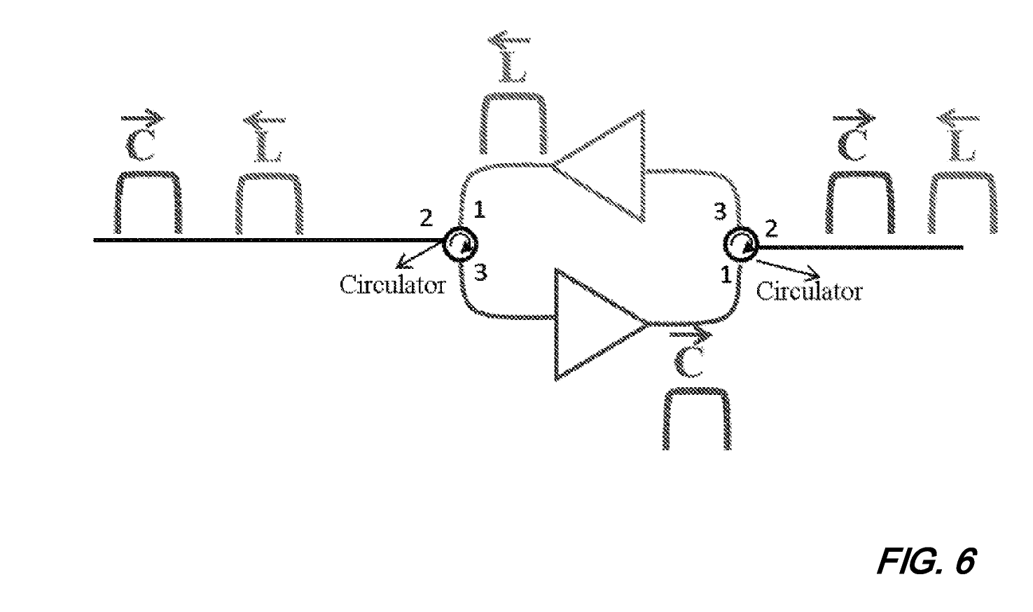

With reference now to FIG. 6, there is shown in schematic form an illustrative configuration of bidirectional C\L amplifier using circulators according to aspects of the present disclosure instead of C\L WDM couplers as known in the art. As may be observed from that figure, each of the circulators has three ports namely, port 1, port 2, and port 3. The circulators operate such that light entering port 1 will exit port 2. Light entering port 2 will exit port 3. Finally, light entering the circulator at port 3 is blocked. From this schematic figure and this description, it may be understood how C-band and L-band traveling in opposite directions are directed into the appropriate amplifiers according to aspects of the present disclosure.

We note at this point a particular advantage of our inventive arrangement according to aspects of the present disclosure as shown in FIG. 6 wherein circulators are employed instead of C\L WDM couplers. More particularly structures according to the present disclosure advantageously allow the removal of a component viewed as necessary in the art namely, an optical isolator which the art employs at the input to EDFAs.

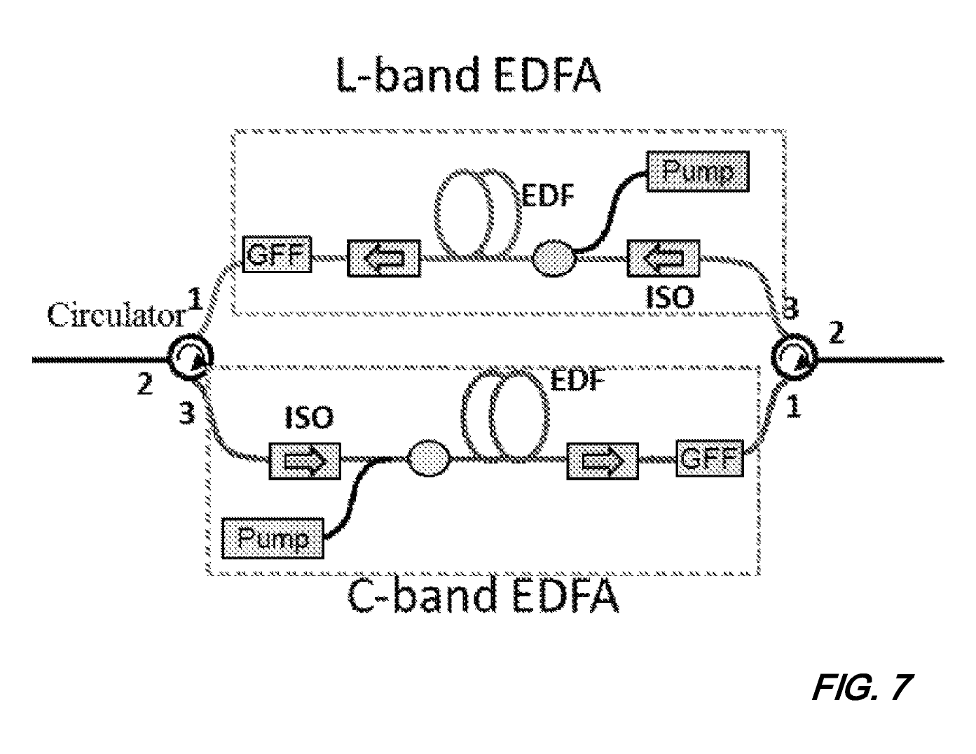

One may more fully appreciate the differences between systems, methods and structures according to the present disclosure and illustratively shown in FIG. 6, by comparison of that structure with one shown schematically in FIG. 7.

With reference to that FIG. 7, it may be observed a conventional fiber amplifier structure that includes a pair of circulators. Other components employed with EDFAs will generally include: GFF—gain flattening filter; EDF—Erbium-doped fiber; and ISO—isolator(s).

Of particular interest to the present disclosure and as shown in FIG. 7, there is positioned an optical isolator prior to the EDF in the optical path(s) and interposed between the EDF and a circulator. Such isolators are required—because—the EDFAs generate amplified spontaneous emission (ASE) noise that travels in a backward direction to that of the signal. This backward ASE (b-ASE) travels in a direction opposite to that of the signal and as such may reflect from the various components and re-enter the EDFA and combine with the signal. Consequently, the noise adds to the signal noise, and degrades the amplifier performance.

Still another problem resulting from b-ASE reentering the EDFA is that it results in runaway feedback mechanisms resulting in instable EDFA output power (or gain). Note that even though reflection from components prior to the amplifier may be avoided, b-ASE is still reflected back by the optical fiber through Rayleigh scattering. Accordingly, it is thought necessary to position an isolator at an entry to the amplifier—that is until systems and methods and structures according to the present disclosure are implemented.

Operationally, and as shown in FIG. 7, light traveling in the direction of the arrows experiences only a small insertion loss which can be as low as 0.1 dB to 1 dB. Light traveling in a direction opposite to the arrow would experience a large loss, which may be as large as 10 dB to 50 dB. Therefore, a signal may enter the EDFA, but any b-ASE generated in the amplifier is blocked by the isolator. However, isolators attenuate the optical signals—by a small but appreciable amount which can range from 0.1 dB to 1 dB.

Consequently, since the isolator must be positioned at an input to the EDFA they effectively increase a noise figure (NF) of the EDFAs by substantially the same amount as the attenuation of the isolators. Note that NF is a measure of the noise performance of amplifiers and that a larger NF indicates a noiser amplifier. As a result, a designer must choose between added noise penalty due to b-ASE reflected back into the signal and the associated instability, or the added NF penalty due to the insertion loss of the isolator.

Advantageously, systems, methods and structures according to the present disclosure overcome such drawbacks by eliminating the necessity for such isolators while still minimizing any b-ASE negative effects.

At this point, while we have presented this disclosure using some specific examples, those skilled in the art will recognize that our teachings are not so limited. Accordingly, this disclosure should be only limited by the scope of the claims attached hereto.

1. An apparatus comprising:
a first optical waveguide having a first end and a second end;
a second optical waveguide having a first end and a second end;
a third optical waveguide having a first end and a second end;
a fourth optical waveguide having a first end and a second end;
a first optical circulator, said first circulator in optical communication with the second end of the first optical waveguide, the first end of the third optical waveguide and the first end of the fourth optical waveguide;
a second optical circulator, said second optical circulator in optical communication with the second end of the third optical waveguide, the second end of the fourth optical waveguide, and the first end of the second optical waveguide,
a first optical amplifier interposed between the first end and the second end of the third optical waveguide;
a second optical amplifier interposed between the first end and the second end of the fourth optical waveguide;
wherein the apparatus is configured such that there are no optical isolators interposed between the circulators and the optical amplifiers.

2. The apparatus of claim 1 configured such that light traverses the third optical waveguide in a first direction, and light traverses the fourth optical waveguide in a second direction, the first direction and the second direction being opposite directions relative to one another.

3. The apparatus of claim 2 configured such that the light traversing the third optical waveguide is substantially C-band light and the light traversing the fourth optical waveguide is substantially L-band light.

4. The apparatus of claim 3 configured such that the light traversing the first optical waveguide includes both C-band light and L-band light wherein the C-band light travels in the first optical waveguide in a first direction and the L-band light travels in the first optical waveguide in a second direction that is opposite to the first direction.

5. The apparatus of claim 3 configured such that the light traversing the fourth optical waveguide includes both C-band light and L-band light wherein the C-band light travels in the fourth optical waveguide in a first direction and the L-band light travels in the fourth optical waveguide in a second direction that is opposite to the first direction.

6. The apparatus of claim 3 configured such that backward Amplified Spontaneous Emissions (b-ASE) generated by the first optical amplifier is blocked by one of the circulators.

7. The apparatus of claim 3 configured such that backward Amplified Spontaneous Emissions (b-ASE) generated by the second optical amplifier is blocked by one of the circulators.

8. The apparatus of claim 3 configured such that no C\L wavelength division multiplexed couplers (C\L WDM couplers) are employed in the apparatus.

9. The apparatus of claim 8 configured such that a gap between the C-band and the L-band is reduced as compared with an optical structure employing C\L WDM couplers.
